(19) United States
(12) Patent Application Publication
(10) Pub. No.: US 2026/0072835 A1
(43) Pub. Date: Mar. 12, 2026

(54) INLINE SAFETY MECHANISM WITH CACHE

(71) Applicant: QUALCOMM Incorporated, San Diego, CA (US)

(72) Inventors: Ghanashyam PRABHU, San Diego, CA (US); Alexis Gabriel Marcel BOUTILLIER, Caen (FR); Subbarao PALACHARLA, San Diego, CA (US); Sriram HARIHARAN, San Diego, CA (US); Deepak Kumar AGARWAL, Bangalore (IN); Satyanarayana AVADHANAM, Bangalore (IN); Yuwen ZOU, San Jose, CA (US); Amit ANEJA, Chandler, AZ (US); Hiral NANDU, South San Francisco, CA (US); Kedar BHOLE, San Diego, CA (US); Raunaq NANDY MAJUMDAR, San Diego, CA (US); Shri PRAKASH, San Diego, CA (US)

(21) Appl. No.: 18/882,560

(22) Filed: Sep. 11, 2024

(51) Int. Cl. G06F 12/0802

(52) U.S. Cl. CPC G06F 12/0802; G06F 2212/60

(57) ABSTRACT

An apparatus includes a central processing unit (CPU) coupled to a system-on-a-chip (SOC) interconnect. The apparatus also includes multiple logic structures coupled to a memory. The apparatus further includes a safety mechanism coupled to and inline with the memory, the logic structures, and the CPU via the SOC interconnect. The safety mechanism comprises a meta cache and is configured to detect errors in one or more of the logic structures and the memory.

### FIELD OF THE DISCLOSURE

Aspects of the present disclosure generally relate to functional safety, and more particularly to an inline safety mechanism with a cache.

### BACKGROUND

Functional safety is an aspect of computer systems design, particularly in automotive, aerospace, industrial automation, and medical device contexts. Functional safety includes implementing mechanisms to increase the likelihood that a system behaves predictably and safely in the presence of faults. Functional safety standards provide frameworks for the development, validation, and verification of safety systems. These standards include rigorous risk assessment, hazard analysis, and the use of redundant and diverse design techniques to mitigate potential hazards. Conventional strategies for implementing functional safety involve safety integrity levels (SILs), fail-safe and fail-operational modes, and comprehensive safety case documentation to demonstrate that safety specifications are satisfied throughout the product lifecycle.

In the automotive industry, automotives are rated via an Automotive Safety Integrity Level (ASIL) rating system. ASIL ratings, ranging from ASIL-A to ASIL-D, categorize the severity of potential hazards and the rigor specified to mitigate the hazards. ASIL-A represents the lowest safety integrity level and is for systems implementing fewer safety measures, while ASIL-D signifies the highest safety integrity level and is awarded to systems implementing more stringent safety protocols. These ratings guide automotive development, validation, and verification processes to increase the likelihood that automotive systems can operate safely even in the presence of faults. The ASIL framework encompasses risk assessment, hazard analysis, and the implementation of redundant and diverse safety mechanisms to prevent or mitigate failures.

### SUMMARY

In some aspects of the present disclosure, a method includes receiving, from an upstream component, a data transaction. The method also includes receiving a cache hit or a cache miss based on executing the data transaction at a meta cache. The method further includes transmitting data from the data transaction downstream based on receiving a cache miss.

Other aspects of the present disclosure are directed to an apparatus. The apparatus includes a central processing unit (CPU) coupled to a system-on-a-chip (SOC) interconnect. The apparatus also includes logic structures coupled to a memory. The apparatus further includes a safety mechanism coupled to and inline with the memory, the logic structures, and the CPU via the SOC interconnect. The safety mechanism comprises a meta cache and is configured to detect errors in one or more of the logic structures and the memory.

In still other aspects of the present disclosure, a non-transitory computer-readable medium with program code recorded thereon is disclosed. The program code is executed by at least one processor and includes program code to receive, from an upstream component, a data transaction. The program code also includes program code to receive a cache hit or a cache miss based on executing the data transaction at a meta cache. The program code also includes program code to transmit data from the data transaction downstream based on receiving a cache miss.

Still other aspects of the present disclosure are directed to an apparatus. The apparatus includes means for receiving, from an upstream component, a data transaction. The apparatus also includes means for receiving a cache hit or a cache miss based on executing the data transaction at a meta cache. The apparatus further includes means for transmitting data from the data transaction downstream based on receiving a cache miss.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a system-on-a-chip (SOC), in accordance with various aspects of the present disclosure.

FIG. 2 illustrates an example of an automobile including systems that may be adapted, configured, or operated in accordance with various aspects of the present disclosure.

FIG. 3 is a block diagram illustrating an Automotive Safety Integrity Level (ASIL) data path.

FIG. 4 is a block diagram illustrating a data path implementing a safety mechanism with a cache, in accordance with various aspects of the present disclosure.

FIG. 5 is a block diagram illustrating an automotive SOC with ASIL domains, in accordance with various aspects of the present disclosure.

FIG. 6 is a block diagram illustrating safety mechanism components, in accordance with various aspects of the present disclosure.

FIG. 7 is a block diagram illustrating a write miss data flow, in accordance with various aspects of the present disclosure.

FIGS. 8A and 8B are block diagrams illustrating a read miss data flow, in accordance with various aspects of the present disclosure.

FIGS. 9A and 9B are block diagrams illustrating memory space separation techniques, in accordance with various aspects of the present disclosure.

FIG. 10 is a block diagram illustrating a cache hit data flow, in accordance with various aspects of the present disclosure.

FIG. 11 is a flow chart illustrating an example process performed, for example, by a safety mechanism, in accordance with various aspects of the present disclosure.

FIG. 12 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration. ” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Several aspects of functional safety management will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

As described, automotive systems executing safety critical applications or functions are rated via an Automotive Safety Integrity Level (ASIL) rating system. The ASILs may be defined in a specific safety standard, such as international organization for standardization (ISO) 26262. For example, the ASILs may provide a risk classification scheme for certain electrical and electronic systems of road vehicles. ISO 26262 provides four ASILs including ASIL A, ASIL B, ASIL C, and ASIL D. ASIL D is the highest classification and corresponds to the highest level of safety measures for avoiding an unreasonable residual risk, and ASIL A is the lowest classification and corresponds to the lowest level of safety measures. ASIL ratings, ranging from ASIL-A (lowest) to ASIL-D (highest), categorize the severity of potential hazards and the rigor specified to mitigate the hazards.

Development of advanced driver assistance systems (ADAS) and automated driving systems (ADS) and associated safety and mission critical applications in the automotive industry have caused many safety critical applications to specify ASIL-D safety ratings. As a result, automotive and chip manufacturers have developed conventional approaches to develop and manufacture ASIL-D hardware. In one approach, a system-on-a-chip (SOC) and memory elements include several components along an inline data path. The components are each individually designed and manufactured to satisfy ASIL specifications, (e.g., ASIL-D or ASIL-C specifications) enabling the entire data path to reach ASIL-D or ASIL-C status. In another approach, some components of the SOC, such as a central processing unit (CPU) and SOC interconnect, are ASIL-D components. Other components downstream of the ASIL-D components are ASIL-B components. Although the present disclosure primarily discusses ASIL-D, the present disclosure is not so limited, as other higher safety integrity data paths are also contemplated, for example, ASIL-C, which is also higher than ASIL-B. These higher safety integrity data paths include additional checks and safety mechanisms in the data path, relative to ASIL-B.

While the conventional approaches enable the achievement of ASIL-D safety ratings, the approaches also present several significant problems. The first approach, where each component along an inline data path is individually designed and manufactured to satisfy ASIL-D specifications, results in significantly larger design area with specific safety mechanisms added to achieve ASIL-D and higher power dissipation, and extended development times. The approach specifies meticulous design and rigorous testing for each component that can be both time-consuming and expensive. The second approach where certain upstream components are ASIL-D, while certain downstream components are ASIL-B, is not able to fulfill the higher safety integrity requirements (for example, ASIL-D or ASIL-C) of the data path from CPU compute clusters to the DRAM. Therefore, it would be desirable to develop improved techniques for obtaining an ASIL-D safety rating in automotive systems. Although the present disclosure is described with respect to ASIL-D and ASIL-B as examples, other ASIL levels are contemplated, as well as other safety requirements.

Various aspects of the present disclosure are directed to an inline safety mechanism with a cache and techniques to obtain an ASIL-D safety rating in automotive systems. In some implementations, an inline data path includes a CPU and an SOC interconnect upstream from a safety mechanism. Multiple logic structures and memory are downstream from the safety mechanism.

The safety mechanism may implement a cache, a cache lookup component, a meta data generator, and a check component to assess the integrity of the downstream components. For instance, the safety mechanism may generate a short code based on a data transaction passing from upstream components to downstream components. If data from the data transaction is later fetched by an upstream component, the safety mechanism may compare the fetched data against the short code to evaluate whether the fetched data is corrupt. The various techniques implemented by the safety mechanism enable the system to achieve an ASIL-D (or ASIL-C, for example) safety rating despite the downstream components having a safety rating below ASIL-D (or ASIL-C).

Moreover, the cache may be used as fast memory by the upstream components, increasing system performance.

Aspects of the present disclosure present several advantages over conventional techniques. For example, the inline safety mechanism provides end-to-end ASIL-D safety protection across logic intensive, complex downstream structures on the data path to system memory. The safety mechanism also creates redundancy that enables the system to detect and correct errors in any downstream component with a lower safety rating. Additionally, the safety mechanism provides for command path separation as well as space separation of data and meta data in system memory, therefore providing ASIL-D protection to the system. Further, aspects of the present disclosure implement light weight short codes. The short codes reduce backend memory bandwidth and memory footprint overhead penalties. The short codes also provide higher performance compared to alternate approaches such as lock-step execution. Still further, a meta cache used for safety mechanism short codes may be repurposed for data caching, leading to performance gains. In some implementations, the cache hit path may achieve ASIL-D protection by duplicating tag check logic and protecting the control path to static random access memory (SRAM) based tag memory.

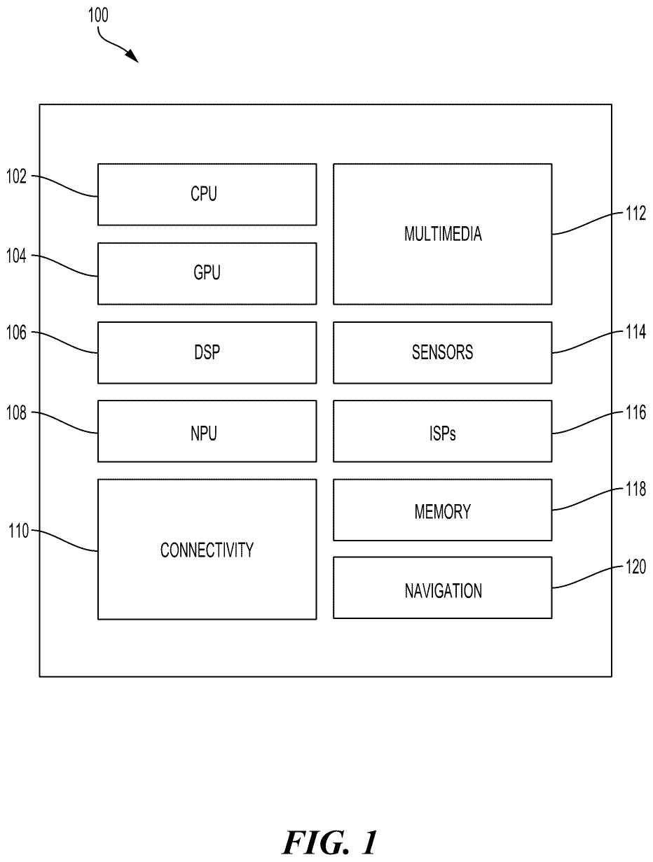

FIG. 1 illustrates an example implementation of a system-on-a-chip (SOC) 100, which may include a central processing unit (CPU) 102 or a multi-core CPU configured for functional safety. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on any architecture, such as a complex instruction set (CISC) architecture, an ARM, RISC-V (RISC-five), or any reduced instruction set computing (RISC) architecture. In aspects of the present disclosure, the instructions loaded into the CPU 102 may include code to receive, from an upstream component, a data transaction. The instructions loaded into the CPU 102 may also include code to receive a cache hit or a cache miss based on executing the data transaction at a meta cache. The instructions loaded into the CPU 102 may further include code to transmit data from the data transaction downstream based on receiving the cache miss.

According to aspects of the present disclosure, an apparatus includes a safety mechanism. The apparatus may include means for receiving, means for transmitting, means for generating, means for caching, means for storing, means for retrieving, and means for comparing.

For example, the means for receiving may be any of the CPU 102, frontend 602, write/read buffers 604, cache lookup component 606, cache 608, safety mechanism meta data generator 614. For example, the means for transmitting may be any of the memory block 118, write/read buffers 604, backend 616, or DRAM 904. For example, the means for generating may be any of the cache lookup component 606, safety mechanism meta data generator 614, or safety mechanism check component 618.

For example, the means for caching may be any of the write/read buffers 604, cache lookup component 606, or cache 608. For example, the means for storing may be any of the memory block 118 or DRAM 904. For example, the means for retrieving may be any of the memory block 118, backend 616, or DRAM 904. For example, the means for comparing may be any of the cache lookup component 606 or safety mechanism meta data generator 614. In other aspects, the aforementioned means may be any structure or any material configured to perform the functions recited by the aforementioned means.

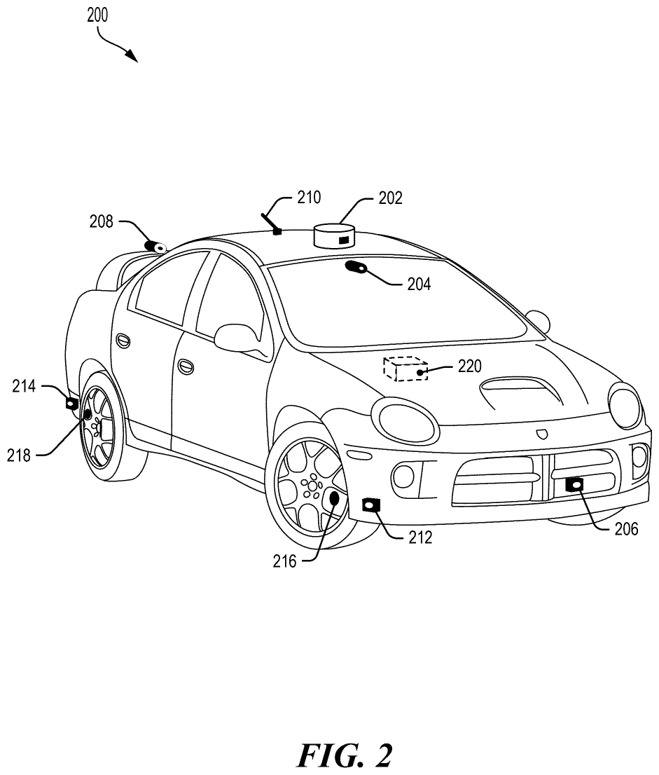

FIG. 2 illustrates an example of an automobile including systems that may be adapted, configured, or operated in accordance with various aspects of this disclosure. The automobile 200 may be equipped with multiple imaging or sensing devices including, for example, cameras 202, 204, 206, 208, 212, 214, and sensors 216, 218. The automobile 200 may include sensors such as tire pressure or braking sensors as the sensors 216, 218. The automobile 200 may also include one or more antennas 210 for radio frequency reception, wireless communication and/or radio navigation using a position location system, such as a global positioning system (GPS). A central controller 220 may be coupled to each of the cameras 202, 204, 206, 208, 212, 214, sensors 216, 218 and antennas 210. The central controller 220 may configure and manage automated systems and/or driver assistance systems. In some implementations, the central controller 220 may be configured to operate as an engine control unit that manages the operation and performance of the engine, motor, motors, or other power systems in the automobile 200. In some instances, the central controller 220 may include an SOC, such as the SOC 100.

Robust data communication links are specified to support the large number of cameras deployed within the automobile 200. In some examples, 20-30 cameras may be deployed to support automation and driver assistance systems. Each camera may be capable of generating data at a rate of between 1-10 gigabits per second (Gbps) resulting in aggregate data rates of up to 300 Gbps.

As discussed, escalating demands in the automotive industry specify an augmentation in safety computation and memory footprints in SOCs. Conventional functional safety design approaches, such as lock-step execution, either do not scale well or carry significant performance trade-offs. The present disclosure presents a data path to system memory that is functionally safer than conventional data paths. The disclosed data path may span complex and logic intensive structures such as compression engines, encryption engines, atomic processors, network-on-a-chip (NOC) interconnects, last-level caches, and memory controllers. Further, various aspects of the present disclosure implement an inline safety mechanism with a cache that provides end-to-end high performance safety protection while decreasing a die area profile. The safety mechanism with a cache also enables memory expansion for Automotive Safety Integrity Level (ASIL)-D computation.

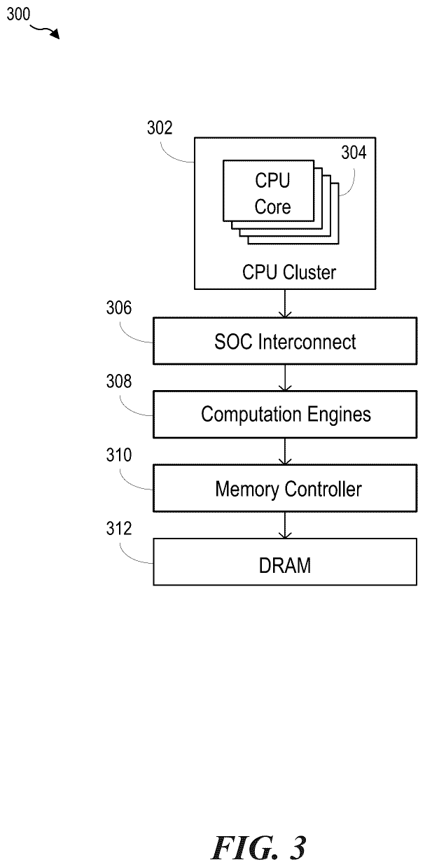

FIG. 3 is a block diagram illustrating an ASIL data path 300. As shown, the data path 300 includes a CPU cluster 302. Although a single CPU cluster 302 is depicted for ease of explanation, the present disclosure is not so limited. The CPU cluster 302 includes a set of CPU cores 304 that work concurrently or in parallel to perform computational tasks via workloads distributed across the set of CPU cores 304. The set of CPU cores 304 are respectively interconnected such that each core may perform a portion of a task. Portions of a task may be assigned to each core of the CPU cores 304 by a scheduler (not illustrated) hosted by the CPU cluster 302. The CPU cluster 302 is coupled to an SOC interconnect 306.

The SOC interconnect 306 links various upstream components, such as the CPU cluster 302 and cache (not illustrated) to various downstream components. Additionally, the SOC interconnect 306 facilitates on-chip communications and transaction handling between the upstream components and downstream components on the data path 300. The SOC interconnect 306 is coupled to computation engines 308. The computation engines 308 represent one or more logic structures on the data path 300 that are downstream from the SOC interconnect 306.

The computation engines 308 may include functionally complex, area intensive logic structures on the path to dynamic random access memory (DRAM) in an SOC. For example, the computation engines 308 may include compression engines, encryption engines, a last-level cache, and other computational or memory structures. Compression engines apply compression techniques to reduce the data footprint of data packets transmitted on the data path 300, thus reducing bandwidth specified to transmit the data packets. Encryption engines implement cryptographic techniques to encrypt data packets. A last-level cache serves as high-capacity, low-latency memory storage for upstream components such as the CPU cluster 302. The computation engines 308 are coupled to a memory controller 310.

The memory controller 310 manages data flow between DRAM 312 and upstream components on the data path 300, such as the CPU cluster 302. The memory controller 310 coordinates memory access requests from the upstream components to reduce memory bandwidth and latency. The DRAM 312, coupled to the memory controller 310, serves as the primary volatile storage for the data path 300, providing memory space for stored information. While smaller data packets and data packets specifying low access latency may be stored in a cache within the data path 300, larger data packets and data packets specifying higher access latency may instead by stored in the DRAM 312 by the memory controller 310.

In FIG. 3, each of the components in the data path 300 may be rated as conforming to the highest safety integrity level, e.g., ASIL-D. Fabricating each of the components to satisfy ASIL-D specifications is expensive and time-consuming. For instance, ASIL-D may specify strict path protection across complex structures, such as the computation engines 308, memory controller 310, and DRAM 312. This path protection may specify path protection techniques that are highly intrusive to the data path 300 and may be over-engineered such that the path protection techniques may be specific to the data path 300 and are not reusable for other data path designs. The ASIL-D classification of each component as shown in FIG. 3 may be associated with one or more undesirable aspects. Similarly, other safety levels, such as ASIL-C, may also be associated with undesirable aspects.

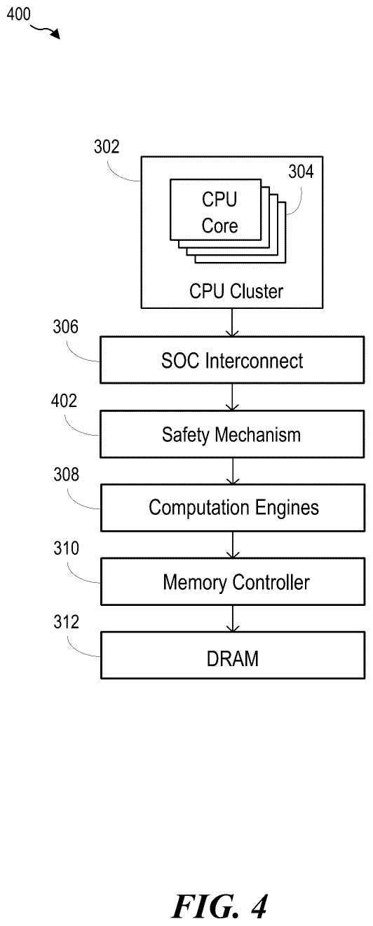

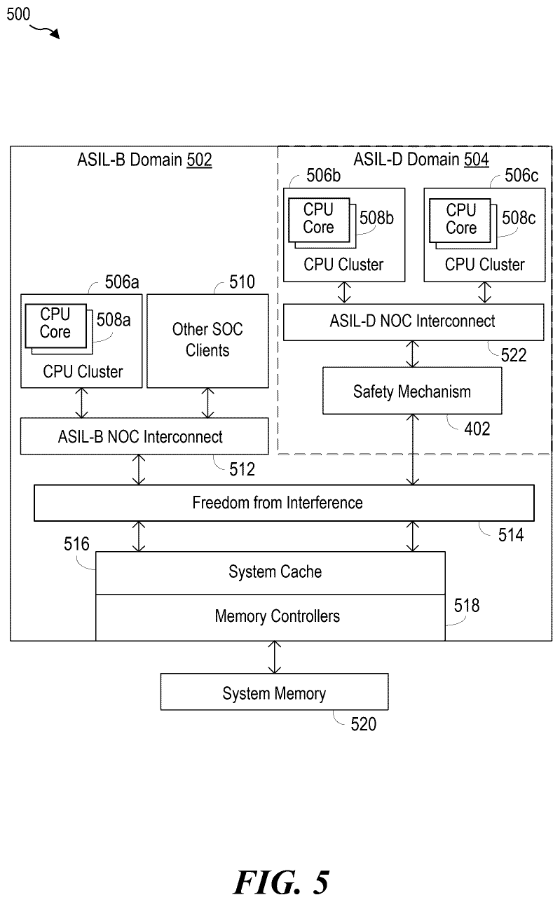

FIG. 4 is a block diagram illustrating a data path 400 implementing a safety mechanism 402 with a cache, in accordance with various aspects of the present disclosure. The data path 400 of FIG. 45 is similar to the data path 300 of FIG. 3, except the data path 400 achieves ASIL-D classification via the safety mechanism 402. The safety mechanism 402 includes a cache and is on the data path 400 between the SOC interconnect 306 and the computation engines 308. The safety mechanism 402 includes architecture enabling the data path 400 to perform data protection techniques for data transmitted downstream of the safety mechanism 402. The architecture and data protection techniques are further discussed with respect to FIGS. 5-10.

The safety mechanism 402 is inline with the CPU cluster 302, SOC interconnect 306, computation engines 308, memory controller 310, and DRAM 312, thus allowing the data path 400 to achieve a low area profile. The safety mechanism 402 enables high performance in aspects such as bandwidth and latency. Additionally, the safety mechanism 402 implements end-to-end systematic safety protection for data packets transmitted downstream to, for example, the DRAM 312. Further, the data path 400 specifies a lower area profile than the data path 400, and the computation engines 308, memory controller 310, and DRAM 312 may individually be rated below ASIL-D, unlike the components in the data path 300 of FIG. 3.

FIG. 5 is a block diagram illustrating an automotive SOC 500 with ASIL domains, in accordance with various aspects of the present disclosure. As shown in FIG. 5, the SOC 500 includes an ASIL-B domain 502 and an ASIL-D domain 504. Each of the components in the ASIL-B domain 502 may have a safety integrity rating of up to ASIL-B, while each of the components in the ASIL-D domain 504 may have a safety integrity rating of up to ASIL-D. The ASIL-B domain 502 includes a first CPU cluster 506a hosting a first set of CPU cores 508a. The ASIL-D domain 504 includes a second CPU cluster 506b hosting a second set of CPU cores 508b. The ASIL-D domain 504 also includes a third CPU cluster 506c hosting a third set of CPU cores 508c. Although a single SoC is described as a domain, the present disclosure contemplates multiple chips, multiple chiplets, multiple die, and/or multiple compute clients as multiple domains.

The ASIL-B domain includes additional SOC clients 510, such as GPUs or other computational structures. The additional SOC clients 510 and the first CPU cluster 506a are both coupled to an ASIL-B NOC interconnect 512. The ASIL-B NOC interconnect 512 may implement packet-based, serialized communication to link various components within the SOC 500. Additionally, the ASIL-B NOC interconnect 512 satisfies ASIL-B standards, but not ASIL-D standards. The ASIL-B NOC interconnect 512 is coupled to a freedom from interference component 514. The freedom from interference component 514 mitigates the risk of failures in one element propagating and causing failures in other elements. For instance, the freedom from interference component 514 may be configured to isolate different elements, such as software components or hardware units, to prevent cascading failures.

The freedom from interference component 514 is coupled to a system cache 516. The system cache 516 is a high-speed memory storage area that temporarily holds frequently accessed data and instructions. Although the system cache 516 hosts less memory capacity than other memory components, such as system memory 520, the system cache 516 provides lower read and write latency than the other memory components. The system cache 516 and freedom from interference component 514 are coupled to memory controllers 518. The memory controllers 518 coordinate memory access requests to the system memory 520. The system memory 520 may be volatile or non-volatile memory for storing memory outside of the SOC 500. For example, the system memory 520 may be RAM.

As discussed, the ASIL-D domain 504 includes a second CPU cluster 506b and a third CPU cluster 506c. Each of the second CPU cluster 506b and third CPU cluster 506c are coupled to an ASIL-D NOC interconnect 522. The ASIL-D NOC interconnect 522, like the ASIL-B NOC interconnect 512, implements packet-based, serialized communication to link various components within the SOC 500. Unlike the ASIL-B NOC interconnect 512, the ASIL-D NOC interconnect 522 satisfies ASIL-D standards. The ASIL-D NOC interconnect 522 is coupled to the safety mechanism 402, and the safety mechanism 402 is coupled to the freedom from interference component 514.

As shown in FIG. 5, the safety mechanism 402 is inline with upstream and downstream components and provides ASIL-D protection on the data path between the CPU clusters 506b, 506c and the downstream memory components, such as the system memory 520. The safety mechanism 402 provides ASIL-D protection without using redundant and area-intensive implementations downstream in, for example, the system cache 516 or memory controllers 518. Additionally, the safety mechanism 402 may be configured to generate a meta code based on a data transaction between a component in the ASIL-D domain 504 and a component in the ASIL-B domain 502 and/or the system memory 520.

The meta code labels data in the data transaction and creates redundancy that enables the SOC 500 to detect and optionally correct errors in components downstream of the safety mechanism 402. The safety mechanism 402 may, for example, generate and/or store an error correction code (ECC), cryptographic hash, or any other error detecting code based on the data transaction. In some implementations, the meta code is shorter than the meta code's respective data transaction. The safety mechanism 402 may include a cache (not illustrated) to store the meta code, providing performance benefits in bandwidth and latency as compared to storing the meta codes in other memory components.

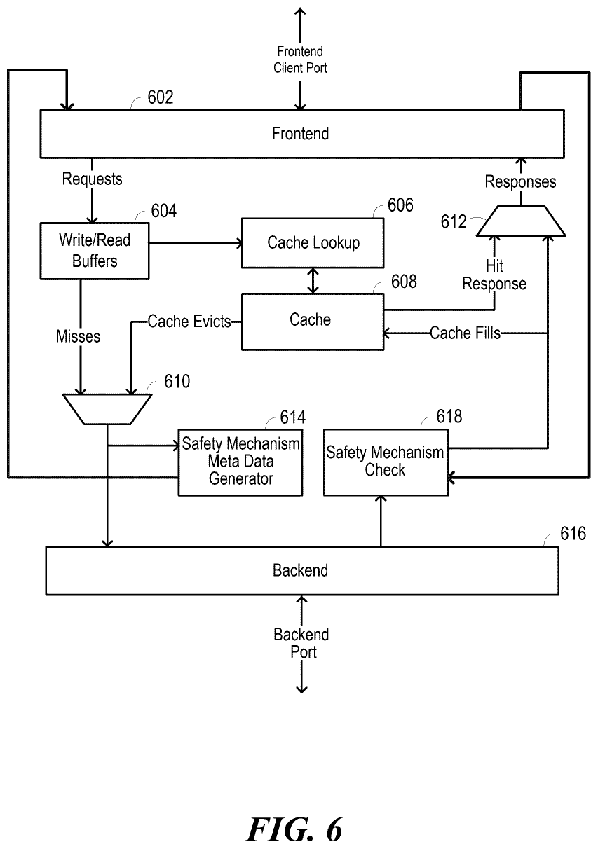

FIG. 6 is a block diagram illustrating safety mechanism components, in accordance with various aspects of the present disclosure. The components illustrated in FIG. 6 may be internal components of the safety mechanism 402. As shown, FIG. 6 includes a frontend 602. The frontend 602 transmits and receives data transactions between the safety mechanism 402 and upstream components, such as a CPU. The frontend 602 is configured to transmit data requests to write/read buffers 604. The write/read buffers 604 temporarily hold data that is being written to memory, such as a cache 608.

The write/read buffers 604 may be configured to work concurrently with a cache lookup component 606 to perform data transactions at the cache 608. For instance, if the safety mechanism 402 attempts to write data to an address not stored by the cache 608 (a “write miss”) during a write transaction, the write/read buffers 604 transmit all or part of the write transaction to a first multiplexer 610. Write misses may also include cold misses where the cache 608 is empty from reset/boot up, capacity misses where the cache 608 is filled, and conflict misses, which are common with set associative caches where two addresses compete for the same structure and thrash over each other. If the safety mechanism 402 attempts to write data to an address stored by the cache 608 (a “write hit”), the write/read buffers 604 may transmit all or a part of the write transaction to the cache lookup component 606 to store data in the cache 608.

The safety mechanism components may also be configured to conduct read transactions. For example, the frontend 602 may receive a data transaction from an upstream component, the data transaction including a read request. All or part of the data transaction may be transmitted to the write/read buffers 604. The cache lookup component 606 may then determine whether a requested data item is present in the cache 608 by comparing the address requested by the read request with the addresses stored in the cache 608. If the data is found (a “read hit”), the cache lookup component 606 retrieves the data from the cache 608 and provides the data to an upstream component, such as a CPU. If the data is not found, (a “read miss”) the cache lookup component 606 may initiate a fetch of the data from a downstream memory component, such as RAM. The cache 608 may be referred to as meta cache.

The cache 608 may remove stored data in a process referred to as a cache eviction. During a cache eviction, the cache 608 may evict data downstream via the first multiplexer 610. For example, the cache 608 may remove the least recently used or least frequently used data from the cache 608 to free up space for new data that is to be stored. If a data transaction is transmitted from the frontend 602 and the data transaction incurs a hit on the cache 608, the cache 608 transmits a hit response to a second multiplexer 612. The second multiplexer 612 then transmits the response to the frontend 602 to be transmitted upstream. For instance, a read request may be transmitted from a CPU to the safety mechanism 402. If the cache 608 hosts the data indicated by the read request, then the cache 608 may transmit the requested data upstream via the second multiplexer 612 and frontend 602.

As discussed, data transactions such as write miss transactions and cache evictions transmit to the first multiplexer 610. The first multiplexer 610 transmits the data transaction to a safety mechanism meta data generator 614. The safety mechanism meta data generator 614, also referred to as a short code generator, generates a meta code based on a data payload of the data transaction and an address of the data transaction. The meta code, also referred to as a short code or a short meta code, is smaller than the data payload and is associated with the data payload and/or address. For example, the short code may be a hash of the data payload and/or address. The safety mechanism meta data generator 614 may then transmit the short code to the frontend 602 such that the short code may transmit to the cache 608 for storing. The first multiplexer 610 concurrently transmits the data transaction to a backend 616.

The backend 616 transmits and receives data between the safety mechanism 402 and downstream components, such as system memory. For instance, the backend 616 may transmit a data transaction to RAM. The backend 616 may also receive a data transaction from downstream components. The backend 616 may then transmit the received data transaction to a safety mechanism check component 618. The safety mechanism check component 618, also referred to as a check component, is configured to assess the integrity of received data transactions. For instance, the safety mechanism check component 618 may receive a data transaction including a data payload. The safety mechanism check component 618 may then compare the data payload with an associated short code received from the cache 608. If the short code matches the data payload, then the data payload is likely not corrupted. If the short code does not match the data payload, then the data payload may be corrupted. The safety mechanism check component 618 may transmit all or part of the data transaction to the cache 608 to store or to the second multiplexer 612 to transmit upstream via the frontend 602. Additionally, the safety mechanism 402 may transmit a corruption indication upstream or downstream based on the data payload matching the short code.

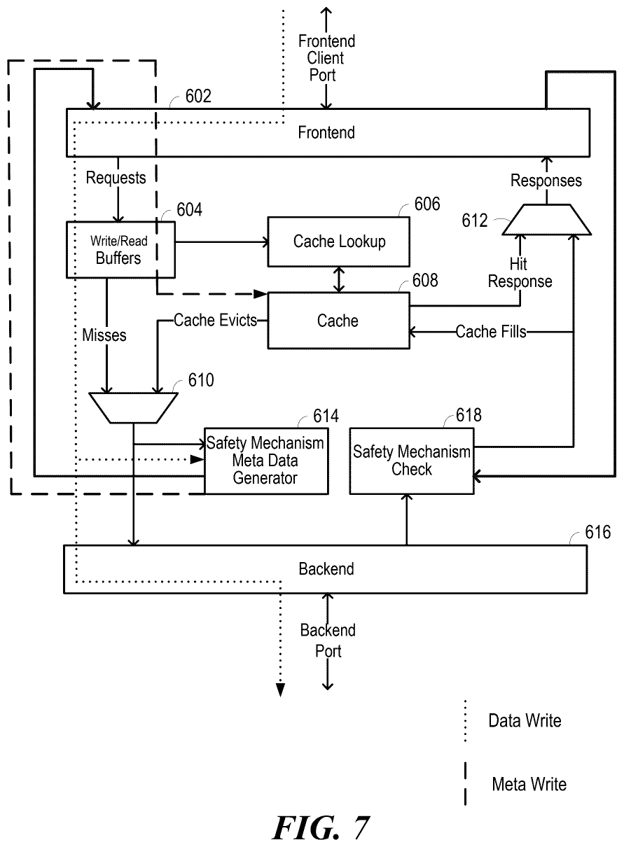

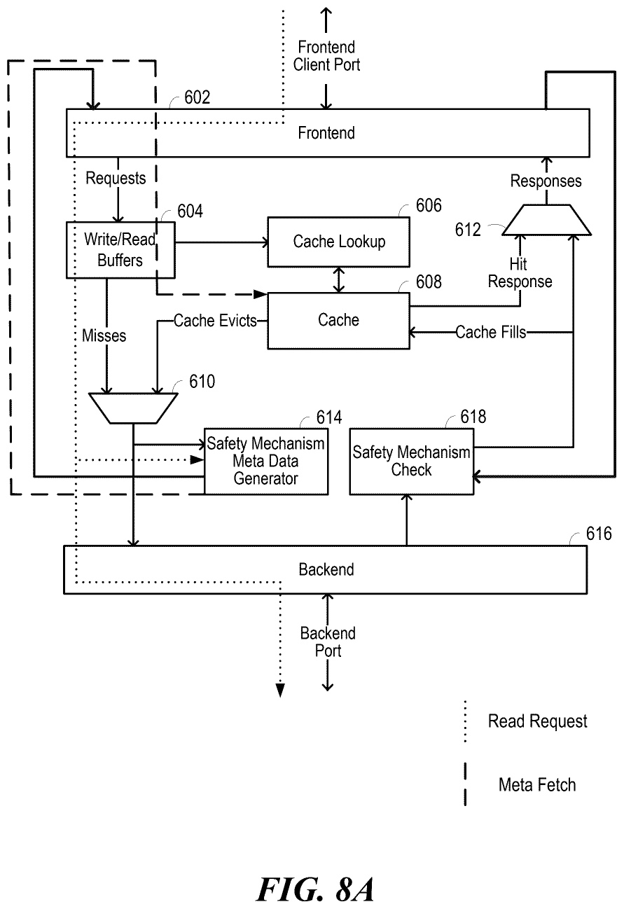

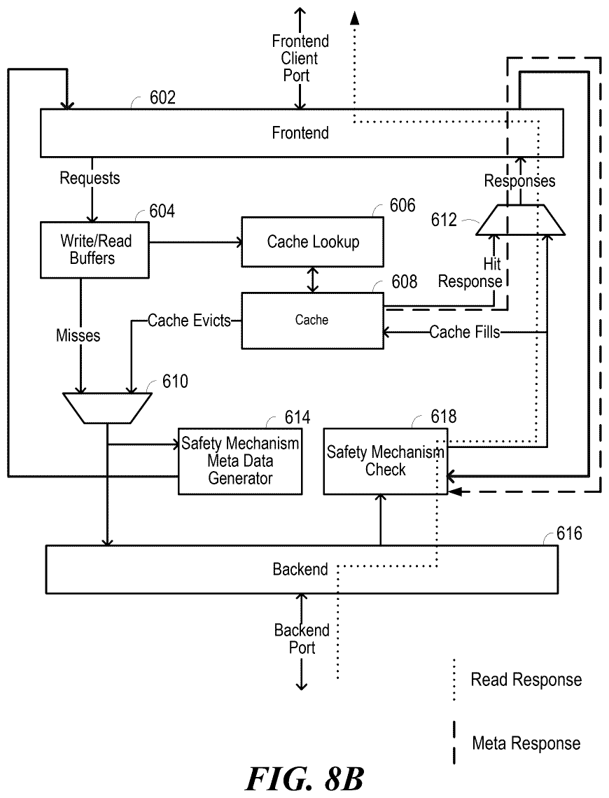

FIG. 7 is a block diagram illustrating a write miss data flow, in accordance with various aspects of the present disclosure. FIG. 7, as well as FIGS. 8-10, use dotted lines to illustrate data flows. For example, FIG. 7 illustrates a data write data flow and a meta write data flow. As shown in FIG. 7, an upstream component, such as a CPU, attempts a write request on the cache 608 by transmitting a data write transaction to the frontend 602. The frontend 602 transmits the write request to the write/read buffers 604. In this example, the data transaction incurs a write miss. Thus, the data transaction transmits from the write/read buffers 604 to the first multiplexer 610 and then to the safety mechanism meta data generator 614.

The safety mechanism meta data generator 614 computes a short code based on the write request. As discussed, the short code may be some representation of all or part of the write request. The first multiplexer 610 then transmits the write request to the backend 616 for transmission downstream. At the safety mechanism meta data generator 614, a write transaction with the short code as payload (a “meta write”) is generated and transmitted to the frontend 602 to be cached in the cache 608. At the cache 608, a meta cache line (not illustrated) packs short codes for multiple sequential data accesses. The short codes for multiple sequential data accesses may be fetched from the cache 608 (“meta fetch”). Because the meta cache line may pack meta codes for multiple sequential data accesses, meta fetches on cache misses are smaller in data size compared to data accesses to the backend 616. For example, meta fetches may specify less bandwidth than read requests issued to the backend 616.

FIGS. 8A and 8B are block diagrams illustrating a read miss data flow, in accordance with various aspects of the present disclosure. As shown in FIG. 8A, an upstream component, such as an SOC interconnect, transmits a read request data transaction to the safety mechanism 402. At the write/read buffers 604, the read request incurs a cache miss and transmits from the write/read buffers 604 to the safety mechanism meta data generator 614 via the first multiplexer 610. For example, the read request may incur a read miss response based on the cache 608 not including requested data. After the safety mechanism meta data generator 614 receives the read request, the safety mechanism meta data generator 614 generates a meta fetch based on the read request. For example, the meta fetch may be based on data requested by the read request and may request a short code that is associated with data specified by the read request. The safety mechanism meta data generator 614 transmits the meta fetch to the frontend 602. The frontend 602 then transmits the meta fetch to the write/read buffers 604, after which the write/read buffers 604 transmit the meta fetch to the cache lookup component 606. The cache lookup component 606 then transmits the meta fetch to the cache 608. Additionally, the read request transmits from the first multiplexer 610 to the backend 616, and the backend 616 transmits the read request to a downstream component such as system memory.

As shown in FIG. 8B, the cache 608 transmits a meta response to the safety mechanism check component 618 upon receiving the meta fetch. The meta response may include a short code associated with the meta fetch and may transmit to the safety mechanism check component 618 while the safety mechanism check component 618 is waiting on a read response for data access from the backend 616. When the backend 616 receives a read response from a downstream component, the backend 616 transmits the read response to the safety mechanism check component 618. At this point, the safety mechanism check component 618 has received the meta response from the cache 608 and the read response from the backend 616. The meta response includes a fetched short code. The safety mechanism check component 618 then recomputes a short code based on the data received in the read response.

After recomputing a short code, the safety mechanism check component 618 compares the recomputed short code with the short code fetched from the cache 608. A compare mismatch indicates data corruption and/or hardware failure. If a compare mismatch occurs, the safety mechanism may generate and transmit an error indication to an upstream or downstream component. If the fetched short code matches the recomputed short code, the read response may transmit to the frontend 602 for transmission upstream of the safety mechanism 402.

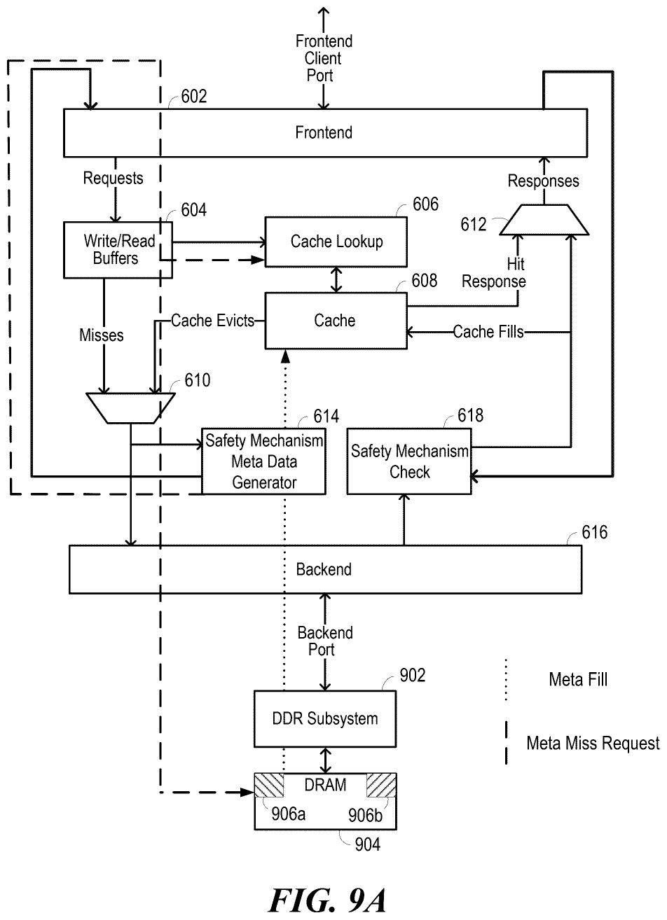

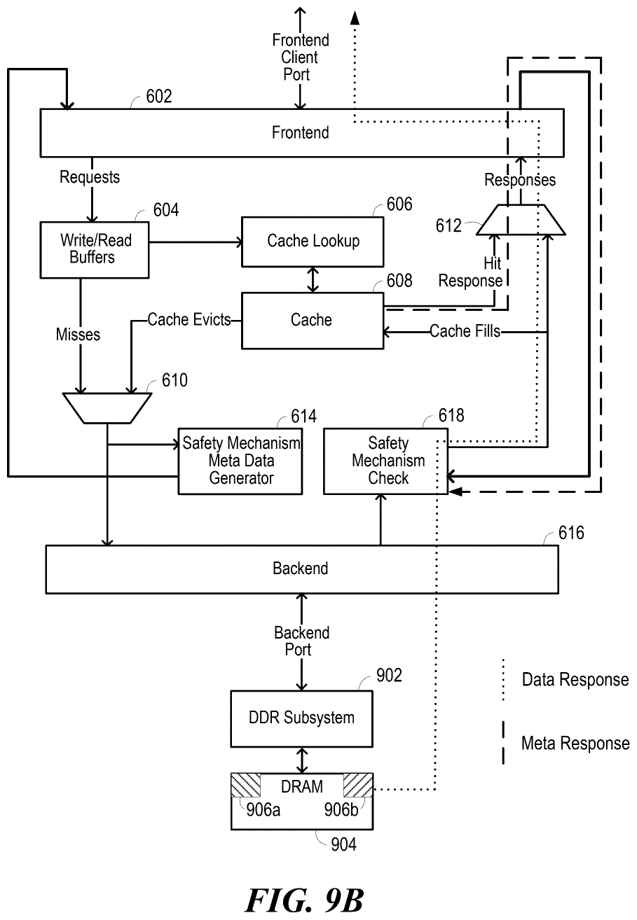

FIGS. 9A and 9B are block diagrams illustrating memory space separation techniques, in accordance with various aspects of the present disclosure. In FIG. 9A, the frontend 602 receives a read request from an upstream component. The read request may be referred to as an “upstream read request,” and the data flow for the upstream read request is not illustrated in FIG. 9A. The upstream read request may incur a read miss while the upstream read request is stored in the write/read buffers 604. As explained with respect to FIG. 8A, the write/read buffers 604 may then transmit the upstream read request to the first multiplexer 610. The first multiplexer 610 may then issue the upstream read request to the backend 616 to fetch data associated with the upstream read request from system memory. The first multiplexer 610 may also transmit the upstream read request to the safety mechanism meta data generator 614.

Upon receiving the upstream read request, the safety mechanism meta data generator 614 may issue a meta read request to the cache lookup component 606. The meta read request is a data transaction that requests a short code based on the upstream read request to be transmitted from the cache 608 to the safety mechanism check component 618. In the example illustrated with respect to FIG. 9A, the meta read request incurs a read miss because the cache 608 does not include the requested short code. In response to the read miss, the write/read buffers 604 transmit the meta read request to the backend 616. The backend 616 transmits a data transaction based on the meta read request to a memory subsystem, such as a double-date rate (DDR) subsystem 902. The DDR subsystem 902 is hosted outside of the safety mechanism 402 and may have a lower safety integrity level, such as ASIL-B. The DDR subsystem 902 is coupled to DRAM 904, the DRAM 904 being downstream of the DDR subsystem 902. Upon receiving the data transaction, the DDR subsystem 902 may transmit the data transaction to the DRAM 904.

The DRAM 904 hosts a first memory region 906a that is physically separated and spaced apart from a second memory region 906b. For example, the DRAM 904 may include an unused or reserved area of memory between the first memory region 906a and the second memory region 906b, creating a gap that prevents the first memory region 906a and the second memory region 906b from being contiguous. The space separation reduces interference between the first memory region 906a and the second memory region 906b, enhancing data integrity and system stability. The first memory region 906a may store meta data, such as short codes, and the second memory region 906b may host other forms of data. The separation in the DRAM 904 between the first memory region 906a and second memory region 906b enables the safety mechanism 402 to provide a safety rating of ASIL-D.

Upon receiving the data transaction requesting a short code, the DRAM 904 initiates a meta fill transaction to the cache 608. The meta fill transaction may include a short code associated with the upstream read request received from the safety mechanism 402. For each address accessed in the DRAM 904, the safety mechanism 402 may deterministically compute an associated meta address in the cache 608 for storing meta data, such as short codes. As discussed with respect to FIG. 8A, if the address for an upstream read request is looked up in the cache 608 and returns a read miss, the requested data may be fetched from system memory, such as the DRAM 904. The safety mechanism meta data generator 614 may then transmit a meta request to the cache 608. The meta request may miss at the cache 608 if, for example, the short code cannot be retrieved from the cache 608. As shown in FIG. 9A, if the meta request misses at the cache 608, the requested meta data may also be fetched from system memory. The safety mechanism 402 may therefore issue two read requests to system memory. One read request is based on the upstream read request and requests data stored at the second memory region 906b. Another read request is for a short code associated with the upstream read request and requests data stored at the first memory region 906a.

Once the safety mechanism 402 fetches the short code from the first memory region 906a, the fetched short code is line filled and read at the cache 608. The cache 608 then transmits the fetched short code to the safety mechanism check component 618. As shown in FIG. 9B, the safety mechanism check component 618 may then compare the fetched short code with a recomputed short code. The recomputed short code is a short code computed by the safety mechanism check component 618 based on the corresponding data response from the second memory region 906b. A mismatch between the fetched short code and the recomputed short code may indicate that the data response received from the second memory region 906b is corrupted or damaged in some manner. Therefore, the safety mechanism check component 618 may invalidate the data response from being stored in the cache if the fetched short code does not match the recomputed short code. If the fetched short code does match the recomputed short code, the safety mechanism check component 618 may transmit the data response to the frontend 602 to be transmitted upstream.

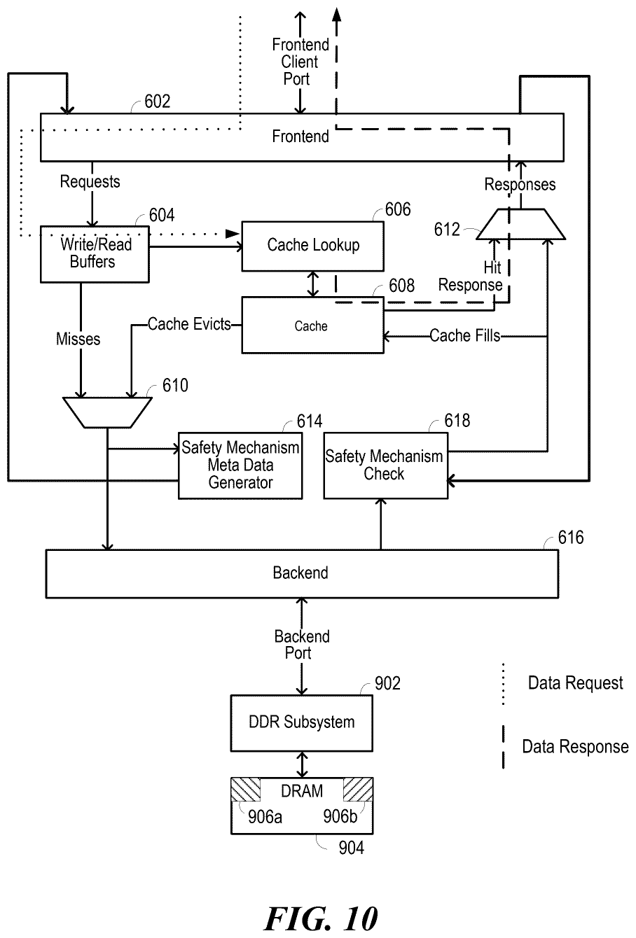

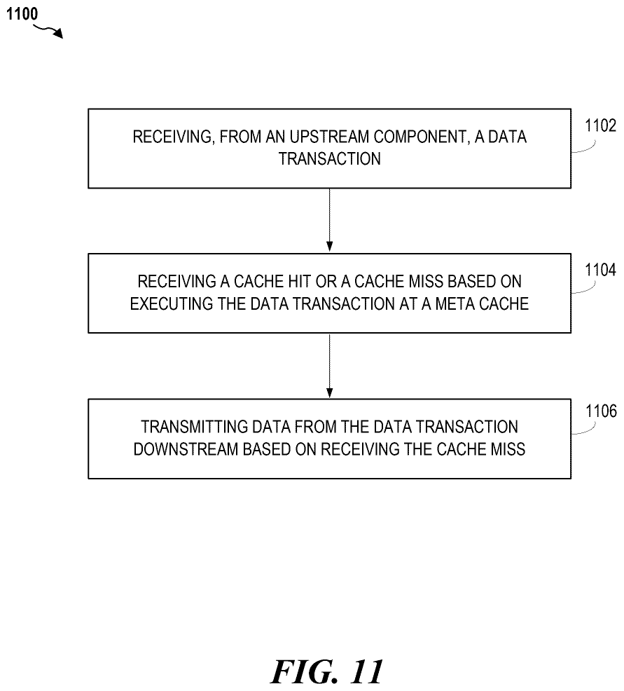

FIG. 10 is a block diagram illustrating a cache hit data flow, in accordance with various aspects of the present disclosure. As discussed, the safety mechanism 402 may receive a data transaction from an upstream component at the frontend 602. The data transaction may be a read request, where the upstream component requests data from the cache 608. The data transaction may be a write request, where the upstream component attempts to write data at an address in the cache 608. The write/read buffers 604 hold the data transaction while the cache lookup component 606 determines whether the data transaction incurs a hit or a miss at the cache 608. For example, a read request incurs a read hit if the cache lookup component 606 finds the requested data in the cache 608. The read request incurs a read miss if the cache lookup component 606 does not find the requested data in the cache 608. A write request incurs a write hit if the cache lookup component 606 determines that the cache 608 includes the data block specified by the write request. A write request incurs a write miss if the cache lookup component 606 determines that the cache 608 does not include the data block specified by the write request.

In order to determine whether a data transaction hits or misses, the cache lookup component 606 implements tag check logic. The tag check logic compares the address specified by the data transaction with tags stored in the cache 608 to check for a match. A match indicates a cache hit. If no match is found, indicating a cache miss, the data may be fetched or written from the DRAM 904. Additionally, the cache lookup component 606 duplicates the tag check logic for redundancy. For example, the cache lookup component 606 may implement lockstep execution to execute the tag check logic in a first pipeline and a second pipeline. The cache lookup component 606 performs the tag check logic for a data transaction in the first pipeline. At substantially the same time, the cache lookup component 606 also performs the tag check logic for the data transaction in a second pipeline.

The cache lookup component 606 may then compare the results of both pipelines to assess component reliability. For example, the cache lookup component 606 may generate a first tag check result and a second tag check result based on receiving a cache hit indication, the second tag check result generated in parallel with the first tag check result. The cache lookup component 606 may compare the first and second tag check results and generate an error indication based on a mismatch between the two tag check results. The cache lookup component 606 may then transmit the error indication upstream or downstream. Additionally, or alternatively, the cache lookup component 606 may process the transaction despite a mismatch between the first tag check result and second tag check result. However, the cache lookup component 606 may issue an interrupt upstream in response to the mismatch, the interrupt being an error indication and having a functional safety “Error”severity.

After determining whether the tag check result from the first pipeline matches the tag check result from the second pipeline, the cache lookup component 606 may determine whether the data transaction hits or misses based on the tag check result. The duplicated tag check logic adds additional reliability to the cache 608, enabling the cache 608 to achieve a safety rating of ASIL-D. Because the cache 608 is ASIL-D rated, upstream components such as a CPU may implement the cache 608 as data cache without compromising ASIL-D reliability. For example, the cache 608 may store both meta data and other forms of data.

As discussed, the cache lookup component 606 may duplicate the tag check logic for both cache hit data flows and cache miss data flows. An example data transaction is illustrated with respect to FIG. 10. In FIG. 10, a data transaction, such as a read request, transmits from an upstream component to the safety mechanism 402. The frontend 602 receives the read request and transmits the data transaction to the write/read buffers 604. The cache lookup component 606 then performs duplicated tag check logic to assess whether the requested data is in the cache 608. In the example of FIG. 10, the read request incurs a read hit, and therefore the read request is not sent downstream, thus avoiding time penalties associated with the system memory access discussed with respect to FIGS. 7, 8A-8B, and 9A-9B. After incurring the read hit, the cache 608 may transmit a data response, including a data payload, to the frontend 602 for upstream transmission.

The example illustrated with respect to FIG. 10 similarly applies to write transactions. For example, an upstream component may transmit a write request data transaction to the safety mechanism 402. The frontend 602 receives the write request and transmits the write request to the write/read buffers 604. The cache lookup component 606 then performs duplicate tag check logic to assess whether the write request specifies an address in the cache 608. When the write request incurs a write hit, the write request is not sent downstream, thus avoiding time penalties associated with the system memory access, as discussed with respect to FIGS. 7, 8A-8B, and 9A-9B. After incurring the write hit, the cache 608 may store data indicated by the write request. The cache 608 may then transmit a data response, including a write confirmation, to the frontend 602 for upstream transmission.

The cache 608 includes tag RAM for storing addresses mapping to data blocks stored by the cache 608. The tags help identify whether a requested address is already in the cache 608 (a cache hit) or should be fetched from the DRAM 904 (a cache miss). Similarly, the cache 608 includes data RAM, also referred to as a data store. The data RAM stores data associated with the tags stored at the tag RAM. In some implementations, the tag RAM and data RAM are both protected via error correction code capabilities, enabling the safety mechanism 402 to achieve an ASIL-D safety rating on the cache hit path. Because the cache hit path is associated with an ASIL-D safety rating, the cache 608 may be repurposed to store data other than meta data. For instance, a CPU may read or write data at the cache 608.

FIG. 1112 is a flow chart illustrating an example process 1100 performed, for example, by a safety mechanism, in accordance with various aspects of the present disclosure. In some aspects, the process 1100 may include receiving, from an upstream component, a data transaction (block 1102). For example, the safety mechanism 402 may receive a read transaction or a write transaction from the SOC interconnect 306. The data transaction may include a data payload for writing to a cache component, such as the cache 608. Additionally, or alternatively, the data transaction may request data from the cache component.

In some aspects, the process 1100 may also include receiving a cache hit or a cache miss based on executing the data transaction at a meta cache (block 1104). For example, a cache lookup component 606 may execute a read transaction received from the upstream component. The cache lookup component 606 may execute the read transaction by determining if requested data is stored at the cache 608. If the requested data is not stored at the cache 608, the cache lookup component 606 receives a read miss. If the requested data is stored in the cache 608, the cache lookup component 606 receives a read hit.

In still further aspects, the process 1100 may further include transmitting data from the data transaction downstream based on receiving the cache miss (block 1106). For instance, if the data transaction is a write operation, and the cache lookup component 606 receives a write miss, the safety mechanism 402 may transmit all or part of the write operation downstream via the backend 616. A data payload associated with the write operation may be transmitted to a data region in memory that is physically separated from a meta region in the memory. For example, the data payload may be stored in the second memory region 906b of the DRAM 904.

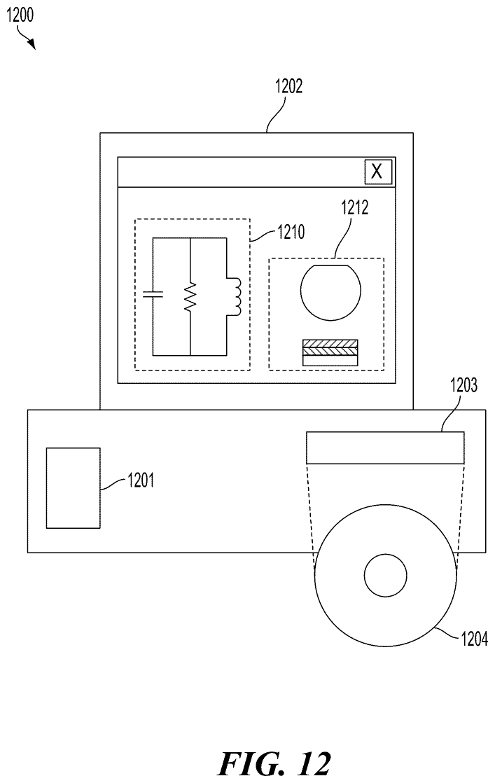

FIG. 12 is a block diagram illustrating a design workstation 1200 used for circuit, layout, and logic design of a semiconductor component, such as the safety mechanism, disclosed above. The design workstation 1200 includes a hard disk 1201 containing operating system software, support files, and design software such as Cadence or OrCAD. The design workstation 1200 also includes a display 1202 to facilitate design of a circuit 1210 or a semiconductor component 1212, such as the safety mechanism. A storage medium 1204 is provided for tangibly storing the design of the circuit 1210 or the semiconductor component 1212 (e.g., the meta cache). The design of the circuit 1210 or the semiconductor component 1212 may be stored on the storage medium 1204 in a file format such as GDSII or GERBER. The storage medium 1204 may be a CD-ROM, DVD, hard disk, flash memory, or other appropriate device. Furthermore, the design workstation 1200 includes a drive apparatus 1203 for accepting input from or writing output to the storage medium 1204.

Data recorded on the storage medium 1204 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 1204 facilitates the design of the circuit 1210 or the semiconductor component 1212 by decreasing the number of processes for designing semiconductor wafers.

### Example Aspects

Aspect 1: An apparatus, comprising: a central processing unit (CPU) coupled to a system-on-a-chip (SOC) interconnect; a plurality of logic structures coupled to a memory; and a safety mechanism coupled to and inline with the memory, the plurality of logic structures and the CPU via the SOC interconnect, the safety mechanism comprising a meta cache and configured to detect errors in one or more of the plurality of logic structures and the memory.

Aspect 2: The apparatus of Aspect 1, in which the safety mechanism further comprises: a short code generator coupled to the meta cache; a cache lookup component coupled to the meta cache; and a check component coupled to the meta cache.

Aspect 3: The apparatus of any of the Aspects 1-2, in which the cache lookup component is configured to: generate a first tag check result based on receiving a data transaction; generate a second tag check result based on receiving the data transaction, the second tag check result generated in parallel with the first tag check result; compare the first tag check result and the second tag check result; and generate an error indication based on the first tag check result not matching the second tag check result.

Aspect 4: The apparatus of any of the Aspects 1-3, in which the short code generator is configured to generate a meta code based on a data payload of a data transaction and an address of the data transaction.

Aspect 5: The apparatus of the Aspects 1-4, in which the memory includes a meta region physically separated from a data region by a gap.

Aspect 6: The apparatus of any of the Aspects 1-5, in which the meta cache is configured to receive and transmit a data payload based on receiving a cache hit indication.

Aspect 7: The apparatus of any of the Aspects 1-6, in which the plurality of logic structures comprises a memory controller, a compression engine, an encryption engine, and a last-level cache.

Aspect 8: A method, comprising: receiving, from an upstream component, a data transaction; receiving a cache hit or a cache miss based on executing the data transaction at meta cache; and transmitting data from the data transaction downstream based on receiving the cache miss.

Aspect 9: The method of Aspect 8, in which the data transaction is a write transaction including a first data payload and the upstream component is a system-on-a-chip (SOC) interconnect, further comprising: receiving a write miss in response to the write transaction failing at the meta cache; and in response to the write miss: generating a first short code based on the first data payload; caching the first short code in the meta cache; and transmitting the first data payload to a memory.

Aspect 10: The method of Aspect 8 or 9, further comprising storing the first data payload at a data region that is physically separated from a meta region by a gap in the memory.

Aspect 11: The method of any of the Aspects 8-10, further comprising: receiving a read transaction for the first data payload, from the SOC interconnect; receiving a read miss based on failing to retrieve the first data payload from the meta cache; and in response to the read miss: retrieving a second data payload from the memory; generating a second short code based on the second data payload; comparing the first short code to the second short code; and generating an error indication based on the first short code not matching the second short code.

Aspect 12:The method of any of the Aspects 8-11, in which comparing the first short code to the second short code comprises: generating a meta request for the first short code; receiving a meta request miss based on failing to retrieve the first short code from the meta cache; and retrieving the first short code from the memory.

Aspect 13: The method of any of the Aspects 8-12, further comprising: generating a first tag check result based on receiving the data transaction; generating a second tag check result based on receiving the data transaction, the second tag check result generated in parallel with the first tag check result; comparing the first tag check result and the second tag check result; and generating an error indication based on the first tag check result not matching the second tag check result.

Aspect 14: The method of any of the Aspects 8-13, in which the error indication is an interrupt.

Aspect 15: An apparatus, comprising: means for receiving, from an upstream component, a data transaction; means for receiving a cache hit or a cache miss based on executing the data transaction at meta cache; and means for transmitting data from the data transaction downstream based on receiving the cache miss.

Aspect 16: The apparatus of Aspect 15, in which the data transaction is a write transaction including a first data payload and the upstream component is a system-on-a-chip (SOC) interconnect, further comprising: means for receiving a write miss in response to the write transaction failing at the meta cache; and in response to the write miss: generating a first short code based on the first data payload; caching the first short code in the meta cache; and transmitting the first data payload to a memory.

Aspect 17: The apparatus of Aspect 15 or 16, further comprising means for storing the first data payload at a data region that is physically separated from a meta region by a gap in the memory.

Aspect 18: The apparatus of any of the Aspects 15-17, further comprising: means for receiving a read transaction for the first data payload, from the SOC interconnect; means for receiving a read miss based on failing to retrieve the first data payload from the meta cache; in response to the read miss: retrieving a second data payload from the memory; generating a second short code based on the second data payload; comparing the first short code to the second short code; and generating an error indication based on the first short code not matching the second short code.

Aspect 19: The apparatus of any of the Aspects 15-18, in which comparing the first short code to the second short code comprises: means for generating a meta request for the first short code; means for receiving a meta request miss based on failing to retrieve the first short code from the meta cache; and means for retrieving the first short code from the memory.

Aspect 20: The apparatus of any of the Aspects 15-19, further comprising: means for generating a first tag check result based on receiving the data transaction; means for generating a second tag check result based on receiving the data transaction, the second tag check result generated in parallel with the first tag check result; means for comparing the first tag check result and the second tag check result; and means for generating an error indication based on the first tag check result not matching the second tag check result.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c”is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. An apparatus, comprising:
a central processing unit (CPU) coupled to a system-on-a-chip (SOC) interconnect;
a plurality of logic structures coupled to a memory; and
a safety mechanism coupled to and inline with the memory, the plurality of logic structures and the CPU via the SOC interconnect, the safety mechanism comprising a meta cache and configured to detect errors in one or more of the plurality of logic structures and the memory.

2. The apparatus of claim 1, in which the safety mechanism further comprises:
a short code generator coupled to the meta cache;
a cache lookup component coupled to the meta cache; and
a check component coupled to the meta cache.

3. The apparatus of claim 2, in which the cache lookup component is configured to:
generate a first tag check result based on receiving a data transaction;
generate a second tag check result based on receiving the data transaction, the second tag check result generated in parallel with the first tag check result;
compare the first tag check result and the second tag check result; and
generate an error indication based on the first tag check result not matching the second tag check result.

4. The apparatus of claim 2, in which the short code generator is configured to generate a meta code based on a data payload of a data transaction and an address of the data transaction.

5. The apparatus of claim 1, in which the memory includes a meta region physically separated from a data region by a gap.

6. The apparatus of claim 1, in which the meta cache is configured to receive and transmit a data payload based on receiving a cache hit indication.

7. The apparatus of claim 1, in which the plurality of logic structures comprises a memory controller, a compression engine, an encryption engine, and a last-level cache.

8. A method, comprising:
receiving, from an upstream component, a data transaction;
receiving a cache hit or a cache miss based on executing the data transaction at a meta cache; and
transmitting data from the data transaction downstream based on receiving the cache miss.

9. The method of claim 8, in which the data transaction is a write transaction including a first data payload and the upstream component is a system-on-a-chip (SOC) interconnect, and the method further comprises:
receiving a write miss in response to the write transaction failing at the meta cache; and
in response to the write miss:
generating a first short code based on the first data payload;
caching the first short code in the meta cache; and
transmitting the first data payload to a memory.

10. The method of claim 9, further comprising storing the first data payload at a data region that is physically separated from a meta region by a gap in the memory.

11. The method of claim 9, further comprising:
receiving a read transaction for the first data payload, from the SOC interconnect;
receiving a read miss based on failing to retrieve the first data payload from the meta cache; and
in response to the read miss:
retrieving a second data payload from the memory;
generating a second short code based on the second data payload;
comparing the first short code to the second short code; and
generating an error indication based on the first short code not matching the second short code.

12. The method of claim 11, in which comparing the first short code to the second short code comprises:
generating a meta request for the first short code;
receiving a meta request miss based on failing to retrieve the first short code from the meta cache; and
retrieving the first short code from the memory.

13. The method of claim 8, further comprising:
generating a first tag check result based on receiving the data transaction;
generating a second tag check result based on receiving the data transaction, the second tag check result generated in parallel with the first tag check result;
comparing the first tag check result and the second tag check result; and
generating an error indication based on the first tag check result not matching the second tag check result.

14. The method of claim 13, in which the error indication is an interrupt.

15. An apparatus, comprising:
means for receiving, from an upstream component, a data transaction;
means for receiving a cache hit or a cache miss based on executing the data transaction at a meta cache; and
means for transmitting data from the data transaction downstream based on receiving the cache miss.

16. The apparatus of claim 15, in which the data transaction is a write transaction including a first data payload and the upstream component is a system-on-a-chip (SOC) interconnect, and the apparatus further comprises:
means for receiving a write miss in response to the write transaction failing at the meta cache; and
in response to the write miss:
means for generating a first short code based on the first data payload;
means for caching the first short code in the meta cache; and
means for transmitting the first data payload to a memory.

17. The apparatus of claim 16, further comprising means for storing the first data payload at a data region that is physically separated from a meta region by a gap in the memory.

18. The apparatus of claim 16, further comprising:
means for receiving a read transaction for the first data payload, from the SOC interconnect;
means for receiving a read miss based on failing to retrieve the first data payload from the meta cache; and
in response to the read miss:
means for retrieving a second data payload from the memory;
means for generating a second short code based on the second data payload;
means for comparing the first short code to the second short code; and
means for generating an error indication based on the first short code not matching the second short code.

19. The apparatus of claim 18, in which comparing the first short code to the second short code comprises:
means for generating a meta request for the first short code;
means for receiving a meta request miss based on failing to retrieve the first short code from the meta cache; and
means for retrieving the first short code from the memory.

20. The apparatus of claim 15, further comprising:
means for generating a first tag check result based on receiving the data transaction;
means for generating a second tag check result based on receiving the data transaction, the second tag check result generated in parallel with the first tag check result;
means for comparing the first tag check result and the second tag check result; and
means for generating an error indication based on the first tag check result not matching the second tag check result.
